(19) United States
(12) Patent Application Publication
(10) Pub. No.: US 2024/0020436 A1
(43) Pub. Date: Jan. 18, 2024

(54) AUTOMATED DATA QUALITY MONITORING AND DATA GOVERNANCE USING STATISTICAL MODELS

(71) Applicant: Capital One Services, LLC, McLean, VA (US)

(72) Inventors: Thomas Oliver CANTRELL, Maidens, VA (US); William Conner RITCHIE, Ashland, VA (US); Sanjay DAGA, Chantilly, VA (US)

(21) Appl. No.: 17/812,840

(22) Filed: Jul. 15, 2022

(51) Int. Cl. G06F 30/20

(52) U.S. Cl. CPC G06F 30/20; G06F 2111/10

(57) ABSTRACT

In some implementations, a data quality system may obtain a historical dataset that includes historical values for a data element. The data quality system may generate one or more statistical summaries for the data element based on the historical values for the data element. The data quality system may generate, using a statistical model, a confidence interval defined by an upper threshold and a lower threshold based on the one or more statistical summaries, wherein the upper threshold and the lower threshold define a predicted range for a current value for the data element. The data quality system may receive a current dataset that includes the current value for the data element. The data quality system may generate an output that indicates whether the current value for the data element is within the predicted range defined by the upper threshold and the lower threshold.

### BACKGROUND

Data quality generally refers to measures or metrics that represent the state of qualitative and/or quantitative data elements. Although there are various measures or metrics that may be used to indicate data quality (e.g., accuracy, completeness, consistency, validity, uniqueness, and/or timeliness, among other examples), data is typically considered high quality when the data is well-suited to serve a specific purpose (e.g., an intended use in operations, decision-making, and/or planning) and/or when the data correctly represents a real-world construct to which the data refers. In some cases, perspectives on data quality can differ, even with regard to the same dataset used for the same purpose. In such cases, data governance may be used to form agreed-upon definitions and standards for quality. For example, data governance may encompass people, processes, and/or information technology needed to consistently and properly handle data across an organization, with key focus areas including data availability, usability, consistency, integrity, security, and standard compliance.

### SUMMARY

Some implementations described herein relate to a system for automated data quality monitoring and data governance. The system may include one or more memories and one or more processors communicatively coupled to the one or more memories. The one or more processors may be configured to obtain a historical dataset that includes historical values for a data element. The one or more processors may be configured to generate one or more statistical summaries for the data element based on the historical values for the data element. The one or more processors may be configured to generate, using a statistical model, a confidence interval defined by an upper threshold and a lower threshold based on the one or more statistical summaries. The one or more processors may be configured to receive a current dataset that includes the current value for the data element. The one or more processors may be configured to generate an output that indicates whether the current value for the data element is within the predicted range defined by the upper threshold and the lower threshold.

Some implementations described herein relate to a method for automated data quality monitoring. The method may include obtaining, by a data quality system, a historical dataset that includes historical values for a data element. The method may include generating, by the data quality system, one or more statistical summaries for the data element based on the historical values for the data element. The method may include generating, by the data quality system, using an auto-regressive integrated moving average (ARIMA) model, a confidence interval defined by an upper threshold and a lower threshold based on the one or more statistical summaries, where the upper threshold and the lower threshold define a predicted range for a current value for the data element, and where the ARIMA model applies weights to the historical values for the data element that are progressively heavier for more recent historical values. The method may include receiving, by the data quality system, a current dataset that includes the current value for the data element. The method may include generating, by the data quality system, an output that indicates whether the current value for the data element is within the predicted range defined by the upper threshold and the lower threshold.

Some implementations described herein relate to a non-transitory computer-readable medium that stores a set of instructions for a data quality system. The set of instructions, when executed by one or more processors of the data quality system, may cause the data quality system to obtain, from a data repository that is updated at periodic intervals, a historical dataset that includes historical values for a data element. The set of instructions, when executed by one or more processors of the data quality system, may cause the data quality system to generate one or more statistical summaries for the data element based on the historical values for the data element. The set of instructions, when executed by one or more processors of the data quality system, may cause the data quality system to generate, using a statistical model, a confidence interval defined by an upper threshold and a lower threshold based on the one or more statistical summaries. The set of instructions, when executed by one or more processors of the data quality system, may cause the data quality system to receive, based on an update to the structured data in the data repository, a current dataset that includes the current value for the data element. The set of instructions, when executed by one or more processors of the data quality system, may cause the data quality system to generate an output that indicates whether the current value for the data element is within the predicted range defined by the upper threshold and the lower threshold.

### BRIEF DESCRIPTION OF THE DRAWINGS

FIGS. 1A-1D are diagrams of one or more example implementations associated with automated data quality monitoring and data governance using statistical models, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of one or more devices of FIG. 2, in accordance with some embodiments of the present disclosure.

FIG. 4 is a flowchart of an example process associated with automated data quality monitoring and data governance using statistical models, in accordance with some embodiments of the present disclosure.

### DETAILED DESCRIPTION

The following detailed description of example implementations refers to the accompanying drawings. The same reference numbers in different drawings may identify the same or similar elements.

Data quality is typically measured using one or more metrics that indicate how well-suited a dataset is to serve a specific purpose (e.g., a data analytics use case). For example, data quality metrics may include an accuracy metric to indicate whether the dataset reflects actual, real-world scenarios, a completeness metric to indicate whether the dataset effectively delivers all available values, a consistency metric to indicate whether the dataset includes uniform and/or non-conflicting values in different storage locations, a validity metric to indicate whether the dataset was collected according to defined business rules and parameters, conforms to a correct format, and/or falls within an expected range, a uniqueness metric to indicate whether there are any duplications or overlapping values across datasets, and/or a timeliness metric to indicate whether the dataset is available when required. In order to determine whether a given dataset is high quality (e.g., fit to serve an intended purpose), an organization may utilize data quality analysts to conduct data quality assessments in which individual data quality metrics are assessed and interpreted to derive intelligence related to the quality of the data within the organization.

In this way, organizations may identify and/or resolve data quality issues, such as duplicated data, incomplete data, inconsistent data, incorrect data, poorly defined data, poorly organized data, and/or poor data security. Furthermore, data quality rules are often an integral component of data governance, which includes processes to develop and establish a defined, agreed-upon set of rules and standards by which all data across an organization is governed. Effective data governance should harmonize data from various data sources, create and monitor data usage policies, and eliminate inconsistencies and inaccuracies that would otherwise negatively impact data analytics accuracy and/or regulatory compliance. However, monitoring data quality and/or managing data governance practices is associated with various challenges because organizations often have large amounts of data stored in databases that are usually updated on a regular basis (e.g., daily, monthly, or at other suitable intervals). For example, having a data analyst manually check each data point is difficult and impractical (e.g., because manually updating threshold allowances when there is a change in circumstances for a data element may require a large number of man-hours), and it is difficult to create data quality rules that are both broad enough to allow for natural variation while still catching true abnormalities. Furthermore, common hard-coded data quality rules that govern a database are typically created by a data analyst using only data that is available at the point in time when the data quality rules are created. In cases where the nature of the data shifts over time (e.g., a change in circumstances results in a durable change to a typical data value), more manpower would be required to update each data quality rule to reflect the new data norm.

For example, when a database is created, subject matter experts usually configure data quality rules that are defined as thresholds (e.g., an upper threshold and a lower threshold defining an expected range for a given data value). In many cases, the thresholds are arbitrary, only intuited by the subject matter expert based on what has occurred in the past. Moreover, considering every data field to define reasonable thresholds that catch data quality problems without causing an excessive number of false positives tends to be very time consuming. In addition to the hours that are spent creating the data quality threshold rules, the rules often need to be updated to reflect how the nature of the data has changed. For example, in a database table that is updated with one row per customer each month, an upload with 1000 rows may reasonably be considered an error or potential data quality concern if the table included 500 rows for 500 customers at the time the table was created. However, if the organization were to expand over time, using a threshold of 1000 rows to flag a potential data quality issue would no longer make sense. Accordingly, in existing data quality systems, the threshold value(s) used in a data quality rule would need to be manually updated. Existing techniques to monitor data quality therefore suffer from various drawbacks, which include wasted manual checks, excessive rule creation time, and/or a tendency to become obsolete over time, among other examples.

Some implementations described herein relate to a data quality system that may automate one or more data quality and/or data governance processes by using statistical models to automatically generate data quality threshold rules that may be updated with each regular upload that includes new data values to reflect trends that may relate to changes in data norms. For example, in some implementations, the data quality system may be used to monitor data quality and/or enable data governance for datasets stored in one or more databases that are updated at regular intervals and contain structured data. For example, for each historical data upload and each current data upload, the data quality system may generate one or more statistical summaries (e.g., a mean, median, and/or maximum value for a numerical data element, a unique item count and/or a missing count for a categorical data element, a missing count and/or a count prior to a cutoff date for a date-based data element, or the like). Accordingly, for each statistical summary, the data quality system may generate a confidence interval that defines a possible or expected range for a data value included in a current or most recent data upload. For example, in some implementations, the confidence interval may be generated using a statistical model, such as an auto-regressive integrated moving average (ARIMA) model, that progressively weights recent data uploads more heavily when calculating the confidence intervals. In this way, when a data element in a newly uploaded dataset has a value that falls outside the confidence interval for one or more statistical metrics, the data quality system may determine that the newly uploaded dataset has a potential data quality issue and may flag the potential data quality issue for data analyst review or involvement. In this way, the data quality system may enable fast and efficient data quality checks on large datasets, and furthermore, the data quality system may dynamically and automatically update the data quality thresholds (or confidence intervals) with each upload. For example, in the use case described above where a threshold of 1000 rows (one per customer) ceases to make sense as an organization expands over time, the data quality system may automatically adjust the thresholds that define the allowable maximum and minimum number of rows as the number of rows included in each upload gradually increases over time.

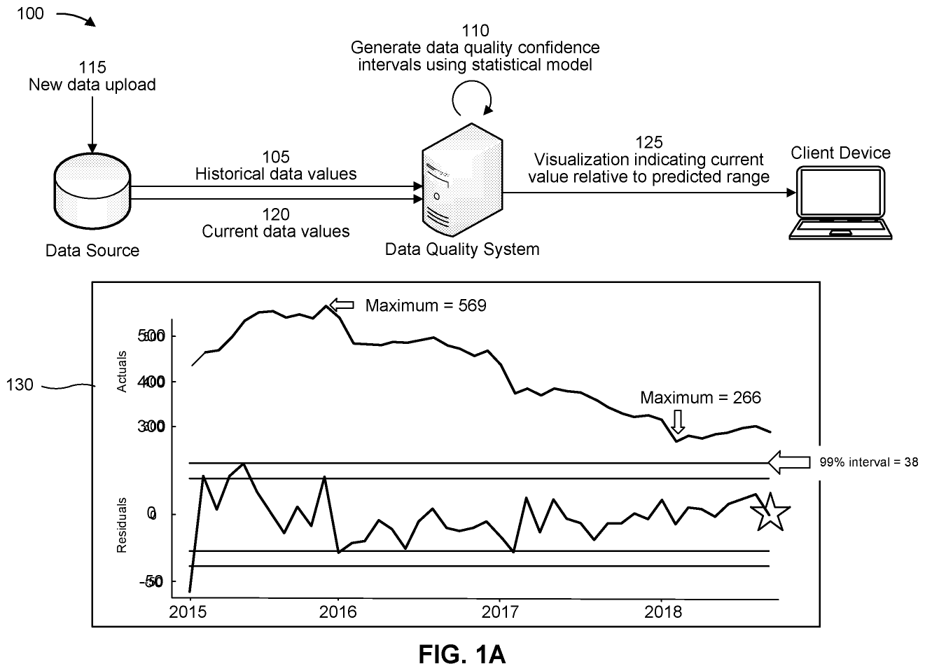

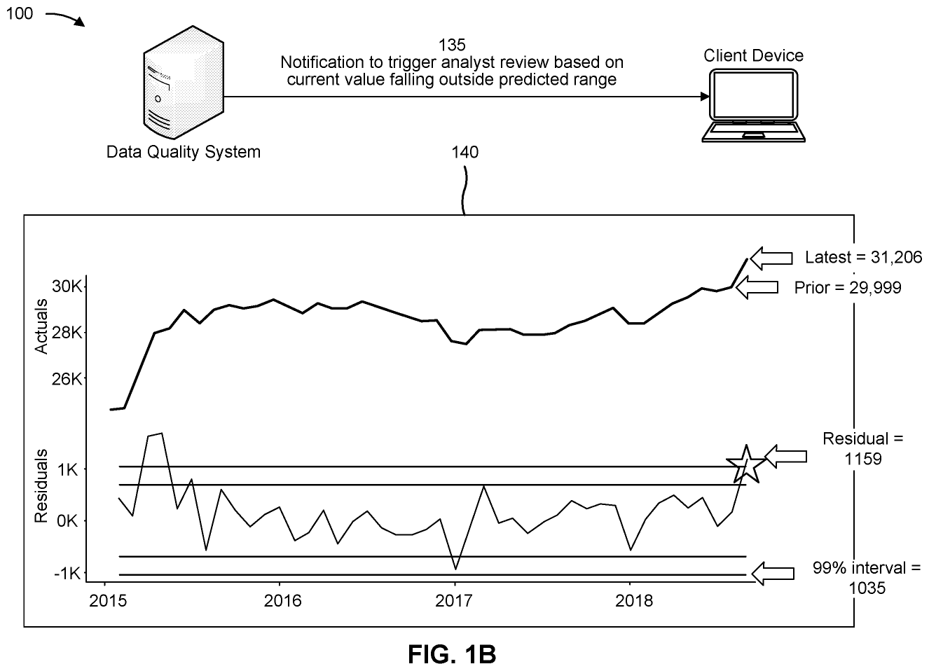

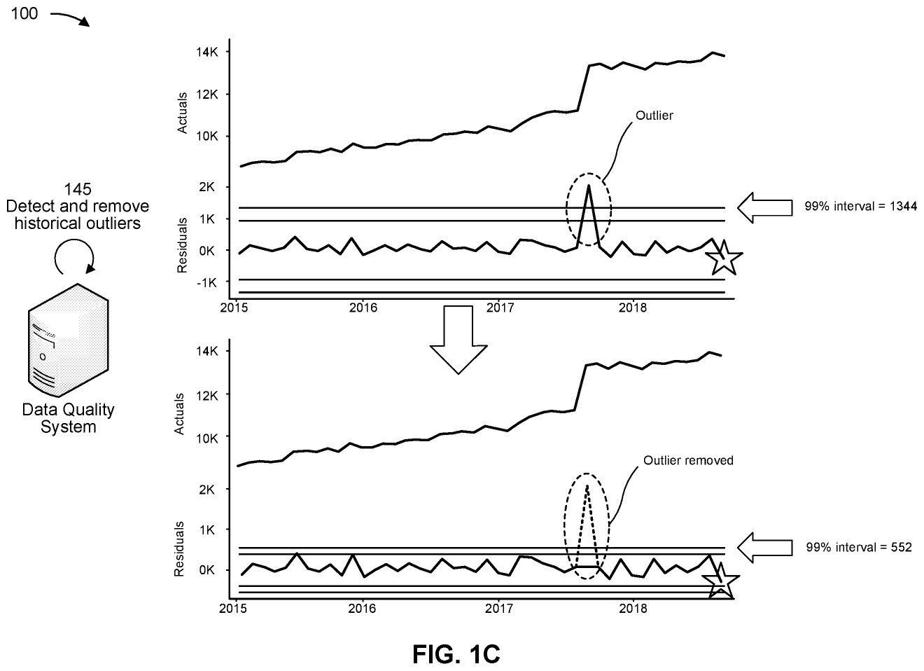

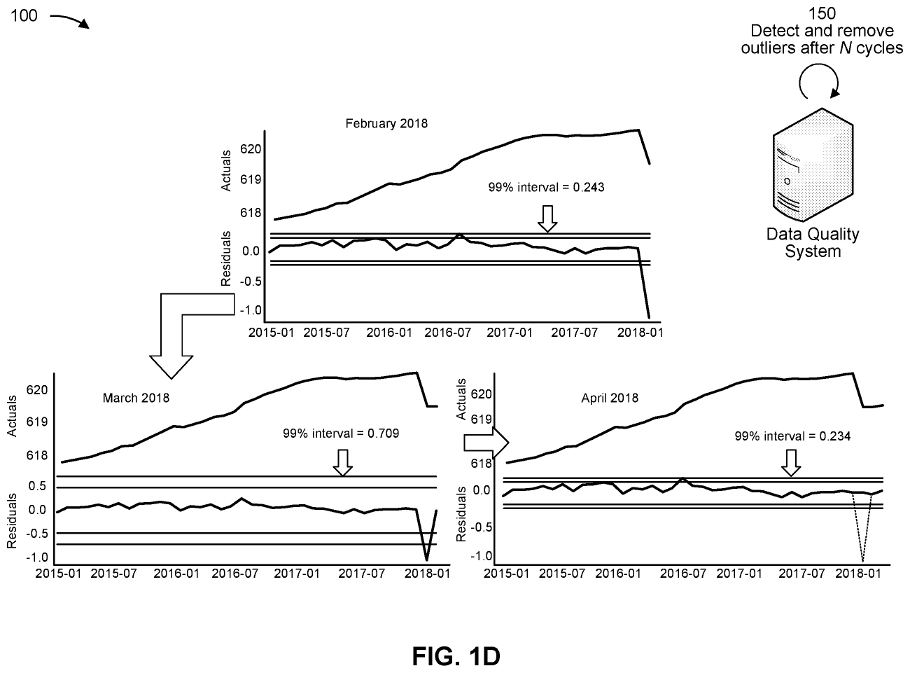

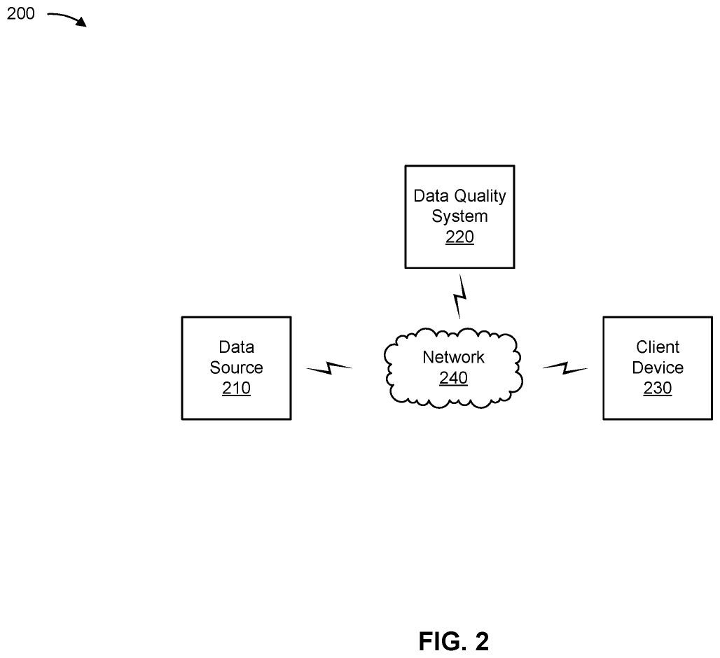

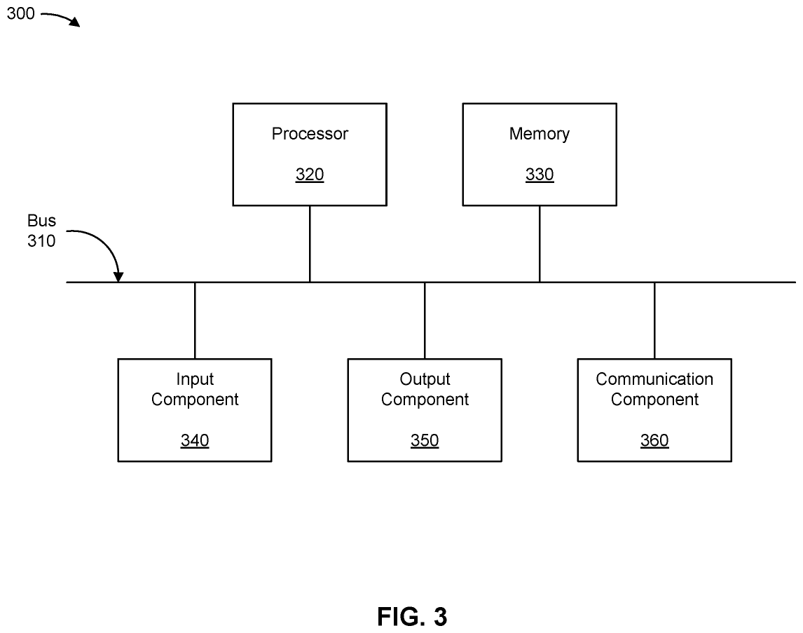

FIGS. 1A-1D are diagrams of an example 100 associated with automated data quality monitoring and data governance using statistical models. As shown in FIGS. 1A-1D, example 100 includes a data source, a data quality system, and a client device. The data source, the data quality system, and the client device are described in more detail in connection with FIGS. 2-3.

As shown in FIG. 1A, and by reference number 105, the data quality system may obtain, from the data source, a historical dataset that includes historical values for one or more data elements. For example, in some implementations, the data source may be updated at periodic intervals (e.g., at a set cadence, such as monthly, weekly, daily, or at other suitable intervals), and the data source may store the historical values for the one or more data elements as structured data. For example, as described herein, structured data may include any suitable data that has an identifiable structure or organization that conforms to a data model or schema, is presented in rows and columns or another tabular format (e.g., in a relational database), is organized such that the data has a definition, format, and meaning that is explicitly understood, and/or organizes information in a manner that is easy to access and query. Accordingly, because the data source is regularly updated at periodic intervals, the structured data that the data quality system obtains from the data source may provide time series data that the data quality system can use to derive data quality rules that can be used to determine whether a current or subsequent dataset uploaded to the data source satisfies requirements related to accuracy, completeness, consistency, validity, uniqueness, and/or timeliness. In particular, as described in further detail herein, the data quality system may use a statistical model or statistical techniques to derive data quality rules in a manner that accounts for changes over time to more accurately determine whether a new dataset is reasonable (e.g., satisfies data quality checks) compared to historical datasets (e.g., the historical data values) that have already been approved.

As further shown in FIG. 1A, and by reference number 110, the data quality system may use a statistical model to generate one or more data quality confidence intervals based on the historical data values obtained from the data source. For example, the historical dataset obtained from the data source may include numerical columns (e.g., for continuous variables), categorical columns, date columns, and/or other suitable data elements, and the historical data values may correspond to a series of data points that are indexed in time order for one or more data elements.

In some implementations, as described herein, the data quality system may use the historical data values obtained from the data source to generate one or more statistical summaries, or features, associated with the historical data values. For example, for a numerical data column associated with multiple rows or other data points for various points in time, the statistical summaries may include a mean value, a median value, a maximum value, a minimum value, one or more percentile values (e.g., a 1^{st} percentile value and a 99^{th} percentile value, although it will be appreciated that other suitable percentiles may be used), a missing count (e.g., a number of rows that are missing a value), a zero count (e.g., a number of rows that have a zero value), and/or other suitable statistics (e.g., a standard deviation, mode, range, or the like) over all of the rows or data points associated with the numerical data column for each point in time. In other examples, a categorical data column may be associated with statistical summaries that may include a count of each unique category and/or a missing count over all of the rows or data points associated with the categorical data column for each point in time, and a date column may be associated with statistical summaries that may include a missing count, a count above a snap date (e.g., a number of rows associated with a date that is after or later than a most recent date of a snapshot taken from the data source, which may be referred to herein as a snap date), and/or a count before a cutoff date (e.g., a number of rows associated with a date that is earlier than an earliest date or year of interest, such as 1940 or another suitable date or year). Furthermore, in some implementations, the statistical summaries may include one or more table-level metrics for each point in time, such as a row count (e.g., a total number of rows included in a table or a total number of rows associated with a column) and/or a duplicate count (e.g., a number of duplicate values in a table or a number of rows associated with a column).

In some implementations, after generating the statistical summaries associated with the historical data values, the data quality system may use a statistical model to generate, for each statistical summary, a confidence interval that defines a range in which data values in a latest data upload should fall. For example, in some implementations, the data quality system may generate confidence intervals that are each defined by an upper threshold and a lower threshold, whereby a latest data upload is expected to have data values that satisfy the upper threshold and the lower threshold. For example, if a confidence interval for a mean transaction amount has an upper threshold of $500 and a lower threshold of $10, the latest data upload may be expected to have a mean transaction amount that is no less than $10 and no more than $500. In some implementations, as described herein, the statistical model used to generate the confidence intervals may generally apply weights to the historical values that are progressively heavier for more recent historical values to capture changes or trends in data values over time (e.g., an average transaction amount may change over time due to changes in an account holder's financial status, such as an increase in income, or due to market inflation or other factors). For example, in some implementations, the statistical model that is used to generate the confidence intervals may be an ARIMA model, which is a univariate time-series model applicable to non-stationary data (e.g., the data has a mean or other properties that change over time). In some implementations, when the data quality system runs the ARIMA model on the historical data values, every value included in the historical dataset except for an initial value may be associated with a predicted range. Accordingly, the data quality system may use the predicted ranges to create a rolling confidence interval for any feature (e.g., a statistical summary, such as a mean, maximum, or the like, or a rolled-up feature, such as null counts, zero counts, or the like) that is reasonably consistent across data loads.

In general, the ARIMA model may be a generalization of an autoregressive moving average (ARMA) model, and may add a notion of integration to the ARMA model. For example, the ARIMA model is autoregressive (AR) in that the ARIMA model uses a dependent relationship between an observation and one or more lagged observations, integrated (I) in that the ARIMA model uses differencing of raw observations (e.g., subtracting an observation from an observation at a previous time step) in order to make the time series stationary, and a moving average (MA) in that the ARIMA model uses the dependency between an observation and a residual error from a moving average model applied to lagged observations. The AR, I, and MA characteristics of the ARIMA model may be specified as parameters, such as by the notation ARIMA(p, d, q), where the p parameter denotes the number of lag observations included in the ARIMA model (also called the lag order), the d parameter denotes the number of times that raw observations are differenced (also called the degree of differencing), and the q parameter denotes the size of the moving average window (also called the order of moving average). Furthermore, a value of zero (0) can be used for a parameter, which indicates that the corresponding aspect is not used in the model. In this way, the ARIMA model can be configured to perform the function of an ARMA model or a simple AR, I, or MA model or another suitable permutation.

In some implementations, in the case of the data quality system described herein, the ARIMA model may be configured with (p, d, q) parameters of (0, 1, 1), which results in simple exponential smoothing. For example, after accounting for trends and seasonality in the historical data values, the data quality system may use the ARIMA(0, 1, 1) model to take an exponentially weighted moving average of past values to predict the confidence interval for a next value, where each forecast is adjusted in a direction of an error made by a previous forecast (e.g., based on a residual representing a difference between an actual value and a predicted value). In this way, the ARIMA model may be configured as a univariate model with no exogenous variables.

In some implementations, as described herein, the data quality system may run the ARIMA model (or another suitable statistical model) on the statistical summaries or other features associated with the historical data values to generate the confidence interval for a next data load. For example, rather than evaluating individual values for a data element (e.g., a numerical column, a categorical column, a date column, a table-level value, or the like), the statistical model used by the data quality system may generate the confidence interval based on the aggregate properties of the values for the data element within each data load. For example, in order to generate a 99% confidence interval that is defined by an upper threshold and a lower threshold for a particular feature of a data load (e.g., the data quality system has a 99% confidence that the feature should have a value between the upper threshold and the lower threshold in a next data load), the data quality system may calculate the threshold(s) as follows:

$$\sqrt{\frac{1}{\sum {α}^{i} - 1} \cdot \sum {α}^{i} \cdot {( {x}_{i} - \frac{\sum {x}_{i} {α}^{i}}{\sum {α}^{i}} )}^{2}} \cdot 3.291$$

where x is a residual value of a feature for which the data quality system is generating the confidence interval for a given snap date, i=1 is a most recent snap date, a is a constant (e.g., with a value of 0.95 or another suitable value), and the multiplier of 3.291 gives the 99% confidence interval (e.g., a different multiplier may be used to calculate a confidence interval of another percentage, such as a 95% confidence interval or the like). In some implementations, in the above formula, the a term is a recency weighting factor that may be used to apply a heavier weight to more recent values, the variable x represents the residual (or model error) for a given snap (e.g., an absolute difference between a prediction made using the ARIMA model for a given snap date and an actual value for that snap date), and the variable i indicates a snap date relative to the current upload, where 1 is the immediately preceding upload, 2 is the upload before the immediately preceding upload, and so on. For example, in a case where the mean customer balance for the previous data upload was $100, but the ARIMA model predicted that the mean customer balance would be $95, the absolute difference or residual is $5, which would result in x₁=1 in the formula given above. In this way, within the historical dataset, each column of each table may be associated with one or more statistical summaries or other suitable features for each data load, and the above formula can be used to create a rolling confidence interval for each respective statistical summary or other suitable feature. In this way, the confidence intervals may be used to determine whether any data element within the data source has a potential data quality issue based on a comparison of the value associated with the feature for a current data load compared to the historical trends across previous data loads.

For example, as shown in FIG. 1A, and by reference number 115, the data source may receive a new data upload (e.g., a periodic data load) that updates one or more rows and/or columns within the data source. Accordingly, as shown by reference number 120, the data quality system may receive or otherwise obtain the current data values from the new data load from the data source, and may compute the appropriate statistical summaries or other features based on the current data values, which may be compared to the corresponding confidence interval to determine whether there is a potential data quality issue for the corresponding data element. Furthermore, the data quality system may generate one or more outputs that indicate whether the current values for the data element satisfy the confidence interval (e.g., are between the upper and lower threshold). For example, as shown by reference number 125, the output(s) may include a visualization that is rendered on the client device to indicate the current value relative to the predicted range defined by the confidence interval.

For example, referring to FIG. 1A, reference number 130 depicts an example visualization that plots average balances for accounts within a certain market segment. As shown in FIG. 1A, the average account balance had a maximum value in 2016, and the average account balance decreased over time before reaching a minimum value in early 2018. As shown, the visualization may depict actual values over time (e.g., the mean or average account balance) as well as residuals that represent differences between the actual values and the predicted values, which are plotted relative to the confidence interval defining the upper threshold and the lower threshold that the actual residual value is expected to fall between. As shown, a simple threshold that was calculated in 2016 would not be valid a couple years later based on the trend of the average account balance decreasing over time. For example, in FIG. 1A, each point along the plot of the actual values represents a value of a statistical summary or feature for a particular data load. Accordingly, the ARIMA model used by the data quality system may make predictions by removing trends and seasonality, which standardizes thresholds across time, and by increasing the weights or emphasis applied to more recent data to create rolling confidence intervals. For example, the confidence interval may become wider if the variance in a data feature were to increase over time, or may alternatively become narrower if the variance in the data feature were to decrease over time. In this way, the data quality system may use the historical data in the data source to run the ARIMA model and obtain a prediction of what the next data upload is going to be, and the data quality system may compare the prediction against the actual data in the next data upload to determine whether the actual data falls within the predicted confidence interval.

In general, the data quality system may take no action in cases where the actual data falls within the predicted confidence interval and/or may generate a report or other suitable information to indicate that the actual data in the current load has passed a data quality check. Alternatively, as shown in FIG. 1B, and by reference number 135, the data quality system may send a notification to the client device to trigger a review by a data analyst if the actual data falls outside the confidence interval (e.g., a statistical summary for the current data load has a value that outside the confidence interval defined by the upper threshold and the lower threshold). For example, referring to FIG. 1B, reference number 140 depicts an example of a data quality check that would be flagged for review by a data analyst, in which case the data quality system may send a notification to the client device to trigger the data analyst review. In the example shown by reference number 140, a visualization of the data quality check includes an upper plot that depicts actual values of a 99^{th} percentile for a total account balance across consumers in a given market segment over time (e.g., based on a delinquency rate and/or a length of time the account has been open), and the visualization also includes a lower plot that indicates residuals of the actual values of the 99^{th} percentile for the total account balance across relative to the confidence interval that is calculated using the ARIMA model described herein. As shown in FIG. 1B, the actual value of the 99^{th} percentile was 29,999 in a previous upload and the actual value of the 99^{th} percentile was 31,206 in a latest upload, which results in a sudden spike in the residual. Accordingly, because the residual of the actual value of the 99^{th} percentile in the latest data upload is outside the rolling confidence interval (e.g., exceeding the upper threshold), the data quality system may generate a notification that is sent to the client device to trigger a data analyst review. For example, in the data analyst review, a data analyst may investigate the sudden spike in the residual to assess whether there is a potential data quality issue or whether the spike is attributable to a business change or another circumstance (e.g., a government stimulus payment that increased account balances for a large number of consumers). In this way, the results of the data analyst review may be used to enable data governance for the latest data upload (e.g., auditing the data stored in the data source, approving the latest data upload when there is an appropriate circumstance to explain why the data is outside the confidence interval, or the like).

Accordingly, as described herein, the data quality system may generate one or more outputs based on whether one or more features (e.g., statistical summaries or other suitable features) of a data element included in a current data upload satisfy a confidence interval that is calculated based on historical values for the one or more features. In particular, as described herein, the confidence interval may be calculated using an ARIMA model or another suitable statistical model that applies progressively heavier weights to more recent data points to account for seasonality and/or trends that change over time, and the one or more outputs may include one or more visualizations indicating whether a current value of a feature associated with a data element in a current data upload (e.g., a mean, median, missing count, zero count, or the like for a numerical data column, a categorical data column, a date column, a table-level parameter, or the like) is within a confidence interval that is predicted for the feature using the statistical model. Additionally, or alternatively, the one or more outputs may include one or more notifications that are provided to the client device to trigger a data analyst review when the current value of a feature associated with a data element in a current data upload is outside the confidence interval that is predicted using the statistical model. Furthermore, as described herein, the data quality system may dynamically update the confidence interval based on the data included in the current data upload in order to enable a similar data quality check for a next data upload. For example, in some implementations, the data quality system may use the historical values of the statistical summaries or other features of the historical data uploads and the current value of the statistical summaries or other features to dynamically recalculate the upper threshold and the lower threshold that define the confidence interval for the next data load. For example, in some implementations, the values of the upper threshold and/or the lower threshold may change due to changes in the real values of the underlying data elements (e.g., the upper and lower thresholds may both increase if there is a trend in which the mean, median, or other statistical feature are increasing, or vice versa). Additionally, or alternatively, the width of the confidence interval may change to reflect a change in a variance among the values of the underlying data elements (e.g., the width of the confidence interval, defined by a difference between the upper threshold and the lower threshold, may increase if there is an increase in the variance of the values of the underlying data elements, or vice versa).

In some implementations, as shown in FIG. 1C, and by reference number 145, the data quality system may detect and remove one or more historical outliers from the values that are used to calculate the confidence interval for a given statistical summary or other data feature (although the outliers are not removed from the original dataset). For example, in cases where there are one or more outliers in the historical data set and/or the current data set and a data analyst declares that the one or more outliers satisfy any applicable data quality parameters after reviewing the outliers, the data quality system may remove the outlier(s) from the values that are used to calculate the confidence interval to avoid a situation in which the outliers cause the confidence interval to be wider than desired or otherwise skewed. For example, in some implementations, a historical outlier may generally occur when there is a one-time event that causes a statistical summary or other feature to have a residual that is outside the confidence interval and the effect of the one-time event continues on afterwards (e.g., due to a business change). Accordingly, the data quality system may perform historical outlier detection by calculating a quantity of standard deviations (e.g., three) for historical residuals to find outlier events, and the corresponding residual outliers may be removed from the values that are used to compute the confidence interval and forward-filled. For example, in FIG. 1C, an upper visualization includes an example of a mean credit line for a credit card over time, where the mean credit line steadily increases at a relatively slow rate until late 2018 when there is a sudden and substantial increase in the mean credit line, which is then followed by another slow and steady increase in the mean credit line. In this example, the residual outlier corresponding to the sudden increase may be validated by a data analyst (e.g., based on a business change resulting in the increase in the mean credit line, such as a willingness to allow consumers to have more debt), but the residual outlier results in a wide confidence interval for the mean credit line. Accordingly, as shown in the lower visualization, the residual outlier may be removed from the set of values that are used to calculate the confidence interval and forward-filled, which results in a much narrower confidence interval (e.g., decreased from 1344 to 552) that more accurately represents the continuing trend of a slow and steady increase in the mean credit line.

In some implementations, as shown in FIG. 1D, and by reference number 150, the data quality system may detect a residual outlier in a current data load, and may wait N cycles (e.g., at least two cycles) to determine whether to remove the residual outlier from the values used to compute the confidence interval. For example, after the N cycles have elapsed, the subsequent data points can be referenced to determine whether a flagged event that caused the residual outlier was a one-time event or attributable to a durable change in circumstances (e.g., the data quality system may be unable to determine whether the flagged event was a one-time event or attributable to a durable change in circumstances at the time that the flagged event occurs). In such cases, the residual outlier may be removed from the values used to calculate the confidence interval if the subsequent data points indicate that the flagged event is associated with a lasting change in circumstances. For example, FIG. 1D illustrates three visualizations that relate to an average credit score for consumers that hold credit card accounts in a market segment. In the illustrated example, the topmost visualization illustrates average credit scores in February 2018, following a business decision to accept more risk and approve consumers with lower credit scores, which results in a sudden decrease in the average credit score (e.g., with a residual much lower than the lower threshold). Accordingly, due to the business decision to accept consumers with lower credit scores, the average credit score plummeted in February 2018, creating a flagged event that would trigger a data analyst review. In this example, the flagged event would be approved as being attributed to a known circumstance. However, as shown in the lower-left visualization, in March 2018, the data point from the previous month is still in the data set, which significantly widens the confidence interval, even though all the data points prior to February 2018 have a very small amount of volatility. Accordingly, as shown in the lower-right visualization, the trend of low volatility continues after the sudden decrease in mean credit score, whereby the data quality system may remove and forward-fill the residual outlier event from February 2018 to return to a narrower confidence interval that better reflects the historical volatility of the statistical feature.

As indicated above, FIGS. 1A-1D are provided as an example. Other examples may differ from what is described with regard to FIGS. 1A-1D.

FIG. 2 is a diagram of an example environment 200 in which systems and/or methods described herein may be implemented. As shown in FIG. 2, environment 200 may include a data source 210, a data quality system 220, a client device 230, and a network 240. Devices of environment 200 may interconnect via wired connections, wireless connections, or a combination of wired and wireless connections.

The data source 210 includes one or more devices capable of receiving, generating, storing, processing, and/or providing information associated with automated data quality monitoring and data governance using statistical models, as described elsewhere herein. The data source 210 may include a communication device and/or a computing device. For example, the data source 210 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data source 210 may communicate with one or more other devices of environment 200, as described elsewhere herein.

The data quality system 220 includes one or more devices capable of receiving, generating, storing, processing, providing, and/or routing information associated with automated data quality monitoring and data governance using statistical models, as described elsewhere herein. The data quality system 220 may include a communication device and/or a computing device. For example, the data quality system 220 may include a server, such as an application server, a client server, a web server, a database server, a host server, a proxy server, a virtual server (e.g., executing on computing hardware), or a server in a cloud computing system. In some implementations, the data quality system 220 includes computing hardware used in a cloud computing environment.

The client device 230 includes one or more devices capable of receiving, generating, storing, processing, and/or providing information associated with automated data quality monitoring and data governance using statistical models, as described elsewhere herein. The client device 230 may include a communication device and/or a computing device. For example, the client device 230 may include a wireless communication device, a mobile phone, a user equipment, a laptop computer, a tablet computer, a desktop computer, a wearable communication device (e.g., a smart wristwatch, a pair of smart eyeglasses, a head mounted display, or a virtual reality headset), or a similar type of device.

The network 240 includes one or more wired and/or wireless networks. For example, the network 240 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. The network 240 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of environment 200 may perform one or more functions described as being performed by another set of devices of environment 200.

FIG. 3 is a diagram of example components of a device 300 associated with automated data quality monitoring and data governance using statistical models. Device 300 may correspond to data source 210, data quality system 220, and/or client device 230. In some implementations, data source 210, data quality system 220, and/or client device 230 include one or more devices 300 and/or one or more components of device 300. As shown in FIG. 3, device 300 may include a bus 310, a processor 320, a memory 330, an input component 340, an output component 350, and a communication component 360.

Bus 310 includes one or more components that enable wired and/or wireless communication among the components of device 300. Bus 310 may couple together two or more components of FIG. 3, such as via operative coupling, communicative coupling, electronic coupling, and/or electric coupling. Processor 320 includes a central processing unit, a graphics processing unit, a microprocessor, a controller, a microcontroller, a digital signal processor, a field-programmable gate array, an application-specific integrated circuit, and/or another type of processing component. Processor 320 is implemented in hardware, firmware, or a combination of hardware and software. In some implementations, processor 320 includes one or more processors capable of being programmed to perform one or more operations or processes described elsewhere herein.

Memory 330 includes volatile and/or nonvolatile memory. For example, memory 330 may include random access memory (RAM), read only memory (ROM), a hard disk drive, and/or another type of memory (e.g., a flash memory, a magnetic memory, and/or an optical memory). Memory 330 may include internal memory (e.g., RAM, ROM, or a hard disk drive) and/or removable memory (e.g., removable via a universal serial bus connection). Memory 330 may be a non-transitory computer-readable medium. Memory 330 stores information, instructions, and/or software (e.g., one or more software applications) related to the operation of device 300. In some implementations, memory 330 includes one or more memories that are coupled to one or more processors (e.g., processor 320), such as via bus 310.

Input component 340 enables device 300 to receive input, such as user input and/or sensed input. For example, input component 340 may include a touch screen, a keyboard, a keypad, a mouse, a button, a microphone, a switch, a sensor, a global positioning system sensor, an accelerometer, a gyroscope, and/or an actuator. Output component 350 enables device 300 to provide output, such as via a display, a speaker, and/or a light-emitting diode. Communication component 360 enables device 300 to communicate with other devices via a wired connection and/or a wireless connection. For example, communication component 360 may include a receiver, a transmitter, a transceiver, a modem, a network interface card, and/or an antenna.

Device 300 may perform one or more operations or processes described herein. For example, a non-transitory computer-readable medium (e.g., memory 330) may store a set of instructions (e.g., one or more instructions or code) for execution by processor 320. Processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry is used instead of or in combination with the instructions to perform one or more operations or processes described herein. Additionally, or alternatively, processor 320 may be configured to perform one or more operations or processes described herein. Thus, implementations described herein are not limited to any specific combination of hardware circuitry and software.

The number and arrangement of components shown in FIG. 3 are provided as an example. Device 300 may include additional components, fewer components, different components, or differently arranged components than those shown in FIG. 3. Additionally, or alternatively, a set of components (e.g., one or more components) of device 300 may perform one or more functions described as being performed by another set of components of device 300.

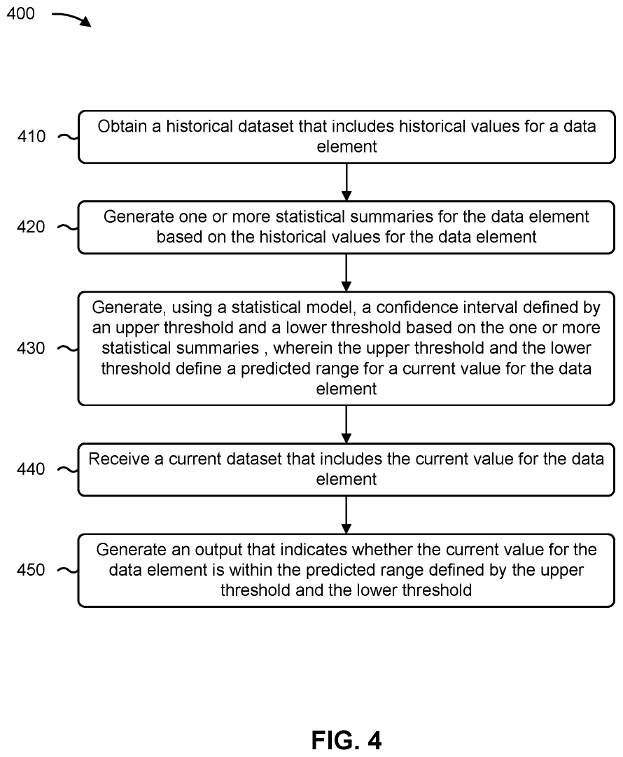

FIG. 4 is a flowchart of an example process 400 associated with automated data quality monitoring and data governance using statistical models. In some implementations, one or more process blocks of FIG. 4 may be performed by the data quality system 220. In some implementations, one or more process blocks of FIG. 4 may be performed by another device or a group of devices separate from or including the data quality system 220, such as the data source 210 and/or the client device 230. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include obtaining a historical dataset that includes historical values for a data element (block 410). For example, the data quality system 220 (e.g., using processor 320, memory 330, and/or communication component 360) may obtain a historical dataset that includes historical values for a data element, as described above in connection with reference number 105 in FIG. 1A. As an example, the data source 210 may store historical values for various data elements (e.g., numerical columns, categorical columns, date columns, or the like) as time-series structured data, which may be obtained by the data quality system 220 to generate one or more thresholds to determine whether subsequent values for the data elements are aligned with historical trends or associated with flagged events that warrant review by a data analyst.

As further shown in FIG. 4, process 400 may include generating one or more statistical summaries for the data element based on the historical values for the data element (block 420). For example, the data quality system 220 (e.g., using processor 320 and/or memory 330) may generate one or more statistical summaries for the data element based on the historical values for the data element, as described above in connection with reference number 110 in FIG. 1A. As an example, the historical dataset may include historical values for a data element corresponding to a numerical data column (e.g., an account balance, a credit score, an available credit line, or the like), and the statistical summaries may include a mean value, a median value, a percentile value, a maximum value, a minimum value, a missing count, a zero count, or the like. In another example, the historical dataset may include historical values for a data element corresponding to a categorical data column (e.g., a vehicle color, a vehicle trim level, or the like), and the statistical summaries may include a count of each unique category, a missing count, or the like. In other examples, the historical dataset may include historical values for data elements corresponding to date columns associated with statistical summaries such as a count of missing date fields and/or a count of date fields before a threshold date, historical values for data elements corresponding to table-level parameters associated with statistical summaries such as a row count and/or a duplicate count, or the like.

As further shown in FIG. 4, process 400 may include generating, using a statistical model, a confidence interval defined by an upper threshold and a lower threshold based on the one or more statistical summaries, wherein the upper threshold and the lower threshold define a predicted range for a current value for the data element (block 430). For example, the data quality system 220 (e.g., using processor 320 and/or memory 330) may generate, using a statistical model, a confidence interval defined by an upper threshold and a lower threshold based on the one or more statistical summaries, wherein the upper threshold and the lower threshold define a predicted range for a current value for the data element, as described above in connection with reference number 110 in FIG. 1A. In some implementations, the upper threshold and the lower threshold define a predicted range for a current value for the data element. As an example, the statistical model may include an ARIMA model or another suitable model that applies progressively heavier weights to data points that are more recent in time. In this way, the statistical model maybe used to compute, based on the statistical summaries associated with the historical values, a confidence interval that defines a predicted range in which a value of each statistical summary should fall for a next data upload.

As further shown in FIG. 4, process 400 may include receiving a current dataset that includes the current value for the data element (block 440). For example, the data quality system 220 (e.g., using processor 320, memory 330, input component 340, and/or communication component 360) may receive a current dataset that includes the current value for the data element, as described above in connection with reference numbers 115 and 120 in FIG. 1A. As an example, the historical dataset may include historical values for one or more numerical data columns, categorical data columns, date columns, and/or other suitable data elements, and the current dataset may include a current value for the numerical data columns, categorical data columns, date columns, and/or other suitable data elements.

As further shown in FIG. 4, process 400 may include generating an output that indicates whether the current value for the data element is within the predicted range defined by the upper threshold and the lower threshold (block 450). For example, the data quality system 220 (e.g., using processor 320 and/or memory 330) may generate an output that indicates whether the current value for the data element is within the predicted range defined by the upper threshold and the lower threshold, as described above in connection with reference numbers 125, 130, 135, and/or 140 in FIGS. 1A-1B. As an example, the output may include one or more visualizations that includes a first plot to indicate the historical and current values of the data element over time and a second plot to indicate residuals between the actual values of the data element and values that were predicted for the data element using the statistical model relative to the confidence interval that was computed for the current value (based on the historical values). Additionally, or alternatively, the output may include a notification that is sent to a data analyst to trigger a review of the current dataset by the data analyst (e.g., in a scenario where the current value for the data element is outside the confidence interval).

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1D. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A system for automated data quality monitoring and data governance, comprising:
one or more memories; and
one or more processors, communicatively coupled to the one or more memories, configured to:
obtain a historical dataset that includes historical values for a data element;
generate one or more statistical summaries for the data element based on the historical values for the data element;
generate, using a statistical model, a confidence interval defined by an upper threshold and a lower threshold based on the one or more statistical summaries,
wherein the upper threshold and the lower threshold define a predicted range for a current value for the data element;
receive a current dataset that includes the current value for the data element; and
generate an output that indicates whether the current value for the data element is within the predicted range defined by the upper threshold and the lower threshold.

2. The system of claim 1, wherein the statistical model is an auto-regressive integrated moving average model.

3. The system of claim 1, wherein the statistical model used to generate the confidence interval applies weights to the historical values for the data element that are progressively heavier for more recent historical values.

4. The system of claim 1, wherein the one or more processors are further configured to:
detect, among the historical values for the data element, one or more historical values associated with residual outliers associated with residual values outside the confidence interval;
remove the residual outliers from a set of values that are used to calculate one or more of the confidence interval or the one or more statistical summaries; and
forward-fill the residual values associated with the removed residual outliers in the set of values used to calculate one or more of the confidence interval or the one or more statistical summaries.

5. The system of claim 1, wherein the one or more processors are further configured to:
determine that the current value for the data element is associated with a residual value that is outside the confidence interval; and
update, after one or more subsequent updates that include new values for the data element, the upper threshold and the lower threshold defining the confidence interval based on whether the residual value that is outside the confidence interval is an outlier.

6. The system of claim 1, wherein the one or more processors are further configured to:
update the one or more statistical summaries for the data element based on the current value for the data element; and
update, using the statistical model, the upper threshold and the lower threshold defining the confidence interval based on the update to the one or more statistical summaries.

7. The system of claim 1, wherein the output includes a notification that is provided to a client device to trigger a data analyst review based on the current value for the data element falling outside the predicted range defined by the upper threshold and the lower threshold.

8. The system of claim 1, wherein the output includes a first plot to indicate actual values for the data element over a time period and a second plot to indicate, relative to the confidence interval, residual values corresponding to differences between the actual values for the data element and predicted values for the data element over the time period.

9. The system of claim 1, wherein the historical values and the current value for the data element are stored as structured data in a data repository that is updated at periodic intervals.

10. A method for automated data quality monitoring and data governance, comprising:
obtaining, by a data quality system, a historical dataset that includes historical values for a data element;
generating, by the data quality system, one or more statistical summaries for the data element based on the historical values for the data element;
generating, by the data quality system, using an auto-regressive integrated moving average (ARIMA) model, a confidence interval defined by an upper threshold and a lower threshold based on the one or more statistical summaries,
wherein the upper threshold and the lower threshold define a predicted range for a current value for the data element, and
wherein the ARIMA model applies weights to the historical values for the data element that are progressively heavier for more recent historical values;
receiving, by the data quality system, a current dataset that includes the current value for the data element; and
generating, by the data quality system, an output that indicates whether the current value for the data element is within the predicted range defined by the upper threshold and the lower threshold.

11. The method of claim 10, further comprising:
detecting, among the historical values for the data element, one or more historical values associated with residual outliers associated with residual values outside the confidence interval;
removing the residual outliers from a set of values that are used to calculate one or more of the confidence interval or the one or more statistical summaries; and
forward-filling the residual values associated with the removed residual outliers in the set of values used to calculate one or more of the confidence interval or the one or more statistical summaries.

12. The method of claim 10, further comprising:
determining that the current value for the data element is associated with a residual value that is outside the confidence interval; and
updating, after one or more subsequent updates that include new values for the data element, the upper threshold and the lower threshold defining the confidence interval based on whether the residual value that is outside the confidence interval is an outlier.

13. The method of claim 10, further comprising:
updating the one or more statistical summaries for the data element based on the current value for the data element; and
updating, using the ARIMA model, the upper threshold and the lower threshold defining the confidence interval based on the update to the one or more statistical summaries.

14. The method of claim 10, wherein the output includes a notification that is provided to a client device to trigger a data analyst review based on the current value for the data element falling outside the predicted range defined by the upper threshold and the lower threshold.

15. The method of claim 10, wherein the output includes a first plot to indicate actual values for the data element over a time period and a second plot to indicate, relative to the confidence interval, residual values corresponding to differences between the actual values for the data element and predicted values for the data element over the time period.

16. A non-transitory computer-readable medium storing a set of instructions, the set of instructions comprising:
one or more instructions that, when executed by one or more processors of a data quality system, cause the data quality system to:
obtain, from a data repository that is updated at periodic intervals, a historical dataset that includes historical values for a data element,
wherein the historical values for the data element are stored as structured data in the data repository;
generate one or more statistical summaries for the data element based on the historical values for the data element;
generate, using a statistical model, a confidence interval defined by an upper threshold and a lower threshold based on the one or more statistical summaries,
wherein the upper threshold and the lower threshold define a predicted range for a current value for the data element;
receive, based on an update to the structured data in the data repository, a current dataset that includes the current value for the data element; and
generate an output that indicates whether the current value for the data element is within the predicted range defined by the upper threshold and the lower threshold.

17. The non-transitory computer-readable medium of claim 16, wherein the one or more instructions further cause the data quality system to:
detect, among the historical values for the data element, one or more historical values associated with residual outliers associated with residual values outside the confidence interval;
remove the residual outliers from a set of values that are used to calculate one or more of the confidence interval or the one or more statistical summaries; and
forward-fill the residual values associated with the removed residual outliers in the set of values used to calculate one or more of the confidence interval or the one or more statistical summaries.

18. The non-transitory computer-readable medium of claim 16, wherein the one or more instructions further cause the data quality system to:
determine that the current value for the data element is associated with a residual value that is outside the confidence interval; and
update, after one or more subsequent updates that include new values for the data element, the upper threshold and the lower threshold defining the confidence interval based on whether the residual value that is outside the confidence interval is an outlier.

19. The non-transitory computer-readable medium of claim 16, wherein the output includes a notification that is provided to a client device to trigger a data analyst review based on the current value for the data element falling outside the predicted range defined by the upper threshold and the lower threshold.

20. The non-transitory computer-readable medium of claim 16, wherein the output includes a visualization that indicates whether the current value for the data element is within the predicted range defined by the upper threshold and the lower threshold.
